(19) United States
(12) Patent Application Publication
(10) Pub. No.: US 2003/0139108 A1
(43) Pub. Date: Jul. 24, 2003

(54) Hard armour panels or plates and production method therefor

(75) Inventors: Wayne Ross Klintworth, Coburg (AU); Ian Crouch, Elwood (AU)

Correspondence Address: BANNER & WITCOFF, 1001 G STREET N W, SUITE 1100, WASHINGTON, DC, 20001, US

(73) Assignee: Australian Defence Apparel Pty Ltd., Coburg (AU)

(21) Appl. No.: 10/316,889

(22) Filed: Dec. 12, 2002

(30) Foreign Application Priority Data
Dec. 14, 2001 (AU) PR9494

(51) Int. Cl. B32B 27/04; B32B 5/02; B32B 27/12

(52) U.S. Cl. 442/134; 428/911

(57) ABSTRACT

The present specification discloses a method of making a hard armour panel or plate (10) including an energy absorbing ceramic tile (11) with a backing element (15) providing structural strength to the ceramic tile (11) adhered to a rear surface thereof, the method involving the steps of forming a stack of interleaved layers (16) of para-aramid fibre fabric interposed by thermoplastic film layers (17) conforming to the peripheral shape of the ceramic tile (11), placing the stack (15) of inter-leaved layers (16, 17) onto a rear face (13) of the ceramic tile (11) and positioning the tile and inter-leaved layers into an autoclave, within the autoclave, subjecting the stack of inter-leaved layers and the ceramic tile to a predetermined temperature and pressure regime for a period of time whereby the backing element (15) is formed into a single piece having a shape exactly conforming to the contour of the rear face (13) of the ceramic tile (11), and utilising high strength adhesive to adhere the backing element (15) to the rear face (13) of the ceramic tile.

The present invention relates to improvements in lightweight armour systems and particularly to hard armour panels or plates intended for the protection of individuals or equipment against higher velocity projectiles, typically being fired from a rifle or the like. The present invention also relates to a novel production method for such hard armour panels or plates that will enable same to be produced effectively and at relatively low cost.

Normally hard armour panels or plates for individual's protection are provided in addition to and work in conjunction with a soft armour vest, but in some applications they may be used as stand alone protective devices. Such plates or panels are usually worn to protect the vital organs of the torso at either (or both) the back and the front of the body. Such hard armour panels and plates are known in the industry comprising composite structures of a core layer of either ceramic material or a metal alloy, either as a single piece or multiple pieces in some form of a side by side array, and a substrate laminate backing structure designed to prevent penetration and captive fragments of the impacting projectile and potentially dislodged fragments of the core layer material, particularly when it is formed by a ceramic material. Examples of such armour plates or panels may be found in Australian Patent Specification No. 12738/99 and U.S. Pat. No. 6,009,789. Australian Patent Specification No. 12738/99 discloses an armour panel where a core layer has a series of layers laminated to its rear surface and to its front surface by gluing or other adhesive means. At least some of the layers extend around the edges of the core layer with some or all of the layers being formed by fabrics of poly-aramid fibres or similar materials. The laminated layers are, subsequent to assembly, impregnated with a polymer like material which is subsequently cured.

The objective of the present invention is to provide a method of making a hard armour panel or plate and the hard armour panel or plate itself of the above described type which will be effective in use but which can be produced in a convenient, efficient and cost effective manner.

Accordingly, the present invention provides a method of forming a hard armour panel or plate including an energy absorbing ceramic tile with a backing element providing structural strength to the energy absorbing ceramic tile adhered to a rear surface of the energy absorbing ceramic tile, said method including the steps of:

(i) forming a stack of inter-leaved layers of para-aramid fibre fabric and at least one thermoplastic film layer conforming to the peripheral shape of the energy absorbing ceramic tile;

(ii) placing said stack of inter-leaved layers onto a rear face of the energy absorbing ceramic tile and positioning the stack of inter-leaved layers and said energy absorbing ceramic tile into a vessel in which pressure and temperature is varied;

(iii) within said vessel, subjecting said stack of inter-leaved layers and the energy absorbing ceramic tile to a predetermined temperature and pressure regime for a period of time whereby said backing element is formed into a single piece having a shape conforming exactly to the contour of the rear face of said energy absorbing ceramic tile; and

(iv) utilising a high strength adhesive to adhere said backing element to the rear face of said energy absorbing ceramic tile.

Conveniently the backing element may be adhered to the rear face of said energy absorbing ceramic tile within said vessel simultaneously with conforming the shape of said backing element to the contour of the rear face of said energy absorbing ceramic tile. Preferably the backing element may be adhered to the rear face of the energy absorbing ceramic tile utilizing a high strength film adhesive as a final layer of said inter-leaved layers.

In a possible alternative process, the backing element may be adhered to the rear face of the energy absorbing tile externally of the vessel.

Conveniently the composite structure of said energy absorbing ceramic tile and said backing element adhered to a rear face of said energy absorbing ceramic tile is placed under vacuum conditions for a predetermined period of time. In one preferred embodiment, a high strength adhesive, such as Hysol, is used to form the composite structure with the structure being placed in a vacuum bag and held under low pressure for a period of time. Conveniently, after the vacuum treatment, the composite structure is allowed to cure under ambient conditions, preferably for about 4 hours.

Preferably, the composite structure may include at least one further strength providing layer adhered to a front face of the energy absorbing ceramic tile. The or each further strength providing layer, in one preferred embodiment, may be adhered to the front face of the energy absorbing tile before being placed in said vessel. This further layer may be a fibreglass fabric layer or a para-aramid spall liner adhered to the front face of the ceramic tile by a high strength adhesive such as a two part epoxy resin or a film adhesive. Conveniently, more than one such further strength providing layers may be provided forward of the energy absorbing tile with each such further strength providing layer being separated by an adhesive layer. The adhesive layer may be a layer or layers of thermoplastic film such as polyethylene, polypropylene or blends of same.

In accordance with a further preferred embodiment, the composite structure may include at least one further strength providing layer (as discussed in the preceding paragraph) adhered to a front face of the energy absorbing ceramic tile, the further strength providing layer or layers being adhered to the front face of the energy absorbing tile within said vessel simultaneously with conforming of the shape of said backing element to the contour of the rear face of said energy absorbing tile. The arrangement may include at least two said further strength providing layers adhered to the front face of the energy absorbing tile, the two further strengths providing layers being inter-leaved with at least one thermoplastic film layer.

To finish the composite plate or panel structure, a nylon cover may be provided to the front and rear surfaces, conveniently by covering the back of the composite with adhesive and applying a nylon cover piece thereto. If desired the rear nylon cover piece may include edge zones of a sufficient size to wrap around the edges of the panel structure and be adhered to the front surface of same. Finally, the front surface of the panel structure may be covered with a suitable adhesive and covered by a front nylon cover piece sized to cover the exposed front surface of the composite structure and the folded edges of the rear nylon cover piece.

The present invention also anticipates providing a hard armour panel or plate made according to the method outlined in the preceding paragraphs.

In a still further aspect, the present invention also provides a hard armour panel or plate including an energy absorbing tile manufactured from an armour grade ceramic having a thickness between 4.0 and 12.0 mm, and a backing element providing structural strength to the energy absorbing tile, said backing element being adhered to a rear surface of said energy absorbing tile and being constructed from inter-leaved layers of para-aramid fibre fabric and thermoplastic polymer film.

Advantageously, between seven and twenty layers of para-aramid fibre fabric are provided in said backing element with each pair being separated by at least one thermoplastic film layer.

Further preferred features of the hard armour panel or plate may be as defined in claims 13 to 15 annexed hereto, which claims are hereby made part of the disclosure of this specification.

Conveniently, the ceramic tile may be made from any known ceramic material used in armour providing applications including alumina oxide. The most preferred ceramic materials are, however, silicon carbide ceramic and boron carbide ceramic which have been found to be effective in absorbing the energy of impacting ballistic projectiles while having a lower bulk density less than that of alumina oxide and a hardness higher than alumina oxide. The thickness of the ceramic tile is typically between 4.0 mm and 12.00 mm, preferably between 6.5 and 9.5 mm. The level of protection is of course increased by increasing the thickness of the ceramic tile and other layers in the composite structure but there is necessarily a trade off between bulk/weight of the panel relative to the level of protection achieved. Typically, the peripheral dimensions of the panel may be approximately between 280 mm×230 mm and 295 mm×245 mm but they can be larger or smaller if desired. Moreover they can be generally rectangular or may be other shapes, as desired. The three-dimensional shape of the hard armour panel may be flat or curved with either a single curvature dimension or complex curvature dimensions.

The para-aramid fibre used to form the fabric layers of such material in the backing element to provide structural strength and to support the ceramic tile may be Kevlar fibre produced by Du Pont such as Style 900, 5HS, Kevlar 49, 308 gsm, scoured, or its equivalent. Conveniently between 7 and 20 layers (preferably between 10 and 15 layers) of such material are used.

Conveniently any thermoplastic polymer film may be used inter-leaved between the layers of fabric formed from para-aramid fibres. It is preferred, however, to use film of polyethylene, polypropylene or blends of same, and more preferably linear low density polyethylene film (LLDPE). Such film is easy to handle, relatively lightweight, inexpensive and provides effective lamination of the para-aramid fibre layers to create a stable monolithic structure for the backing element of the composite panel structure.

Throughout this specification including the accompanying patent claims, “rear surface” or similar wording is intended to identify a surface intended to face toward the user when the hard armour panel is being worm. Similarly, “front surface” or similar wording is intended to identify a surface intended to face away from the user when the hard armour panel is being worn.

The hard armour panel structure and its method of manufacture as described above will be better understood from the following description given in relation to the accompanying drawings of preferred embodiments, in which:

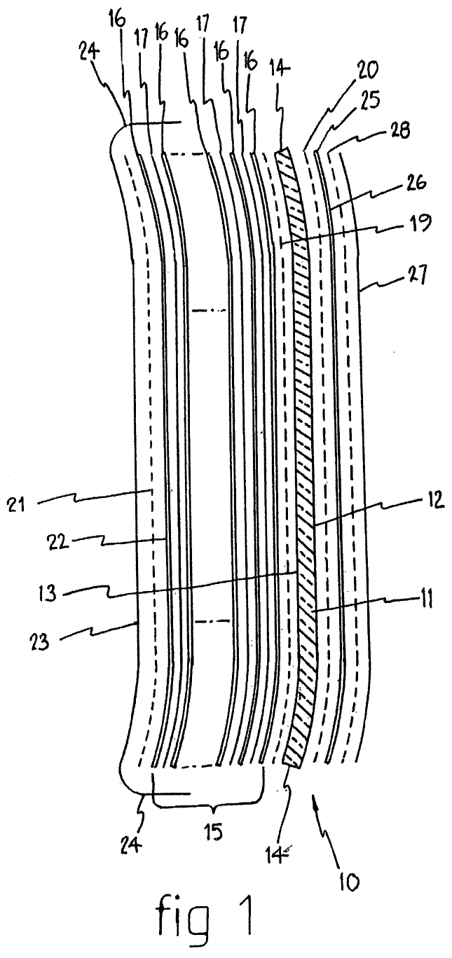

FIG. 1 is a partially exploded cross-sectional view of the layers making up a hard armour panel or plate according to a first preferred embodiment of this invention; and

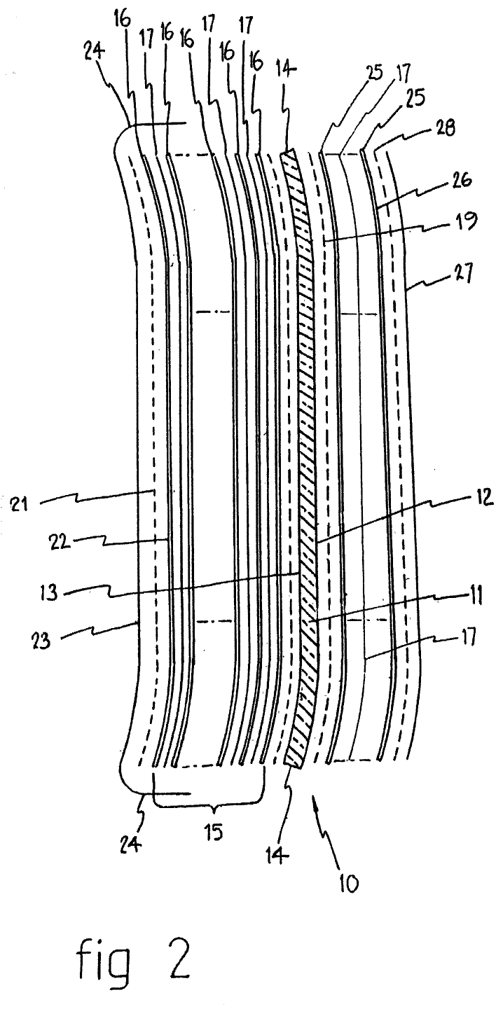

FIG. 2 is a view similar to FIG. 1 showing a possible alternative preferred embodiment of this invention.

Referring to FIG. 1 of the accompanying drawings, the various layers forming a composite hard armour panel according to a first preferred embodiment of the present invention are shown schematically in an exploded or separated form for the sake of clarity, it being recognised that in the completed product, the various layers are joined or adhered to one another. The hard armour panel 10 includes a core ceramic tile 11, configured as required having a front surface 12, a rear surface 13 and a peripheral edge 14. A backing element 15 is provided formed by a plurality separate of layers, being para-aramid fibre fabric layers 16 separated by at least one thermoplastic film layer 17, such as polyethylene, preferably LLDPE. The backing element 15 is formed into a monolithic structure with a front surface 18 conforming exactly to the shape of the rear surface 13 of the ceramic tile 11 as is described in greater detail hereafter. Thereafter, the backing element 15 is secured to the rear surface 13 by the use of an adhesive 19. In one possible arrangement, the hard armour panel or plate may include only the ceramic tile 14 with the backing element 15 secured thereto. It is, however, preferred that a further strength providing layer such as a fibre glass spall liner layer 25 be also provided covering the front surface 12 of the ceramic tile 11 and adhered thereto by an adhesive 20. Finally, a water impervious protective nylon rear cover layer 23 may be adhered via adhesive 21 to the rear surface 22 of the backing element 15 with edge portions 24 of sufficient length to wrap over the ceramic tile peripheral edge 14 and be adhered to at least peripheral zones of the front surface 26 of the fibreglass spall liner layer 25. A water impervious protective nylon front cover sheet 27 may then be adhered via an adhesive 28 to the front surface of the layer 25 and the forward edges of the rear cover layer 23.

FIG. 2 of the accompanying drawings shows an arrangement similar to FIG. 1 except that multiple further strength providing layers 25 might be provided adhered to the front face 12 of the ceramic tile 11. These further layers 25 may be either or both fibre glass fabric and/or para-aramid fabric layers and may be inter-leaved with one or more thermoplastic layers similar to the construction of the backing element 15.

The following provides an illustrative, non-limiting, example of the materials used and a preferred method of construction according to the present invention. The ceramic tile 11 may conveniently be a silicon carbide ceramic having a thickness between 7.5 and 9.5 mm, depending on the level of protection required. The ceramic tiles may be generally rectangular with dimensions approximating 280 mm×230 mm to 295 mm×245 mm. The mass of such ceramic tiles varies between 1200 gms to 2100 gms.

The para-aramid fibre layers 16 of the backing element 15 are fabric layers formed from Kevlar fibres such as Style 900, 5HS, Kevlar 49, 308 gsm produced by Du Pont. Between 10 and 15 plies of Kevlar fabric layers 16 are provided. The number of layers are varied depending on the level of protection desired.

The thermoplastic layers 17 are formed by polyethylene material having the following specifications:

| | |
|---|---|
| Grade: | LLDPE |
| Composition: | Bimodal blend |
| Colour (Haze): | Transparent or Opaque |
| Bulk density: | >0.93 g/cc |
| Thickness: | 0.100 to 0.150 mm |

During the production process as described hereinafter, the polyethylene is at least partially impregnated into the Kevlar fabric layers 16.

The backing element 15 is fixed to the rear surface of the ceramic tile 11 by a high strength adhesive 19 such as HYSOL EA 9309NA, a two part epoxy resin produced by the Dexter Corporation or a film adhesive. This adhesive can be used as the adhesive 20 for fixing the fibreglass or para-aramid spall liner layer 25 to the front surface 12 of the ceramic tile 11. The fibreglass or para-aramid spall liner layer 25 used may be E-Glass, 4HS, 107 gsm to Specification BMS 9-3N, Type D, Class 7. The nylon cover layers 23, 24, 27 are provided to provide physical protection and to resist the ingress of water into the composite structure. The nylon fabric used may be 500 Denier with a polyurethane coating having a minimum hydrostatic head of 1000 mm. The cover sheets are fixed in position preferably using 3M Brand Spray 90 High Strength adhesive (XA-4976) and is then heat sealed to fix the cut edges.

The manufacturing process may be as follows:

1. Cutting of soft materials (Kevlar, polyethylene, fibreglass, nylon, and if used, film adhesive) to the pattern based on the desired ceramic tile shape. The ceramic tile may have one or more further strength providing layers already adhered to the front face of the tile.

2. Lay up of the ceramic tile with or without the forwardly located strength providing layers with the backing layers of, Kevlar and polyethylene such that the appropriate number of Kevlar sheets are stacked with inter-leaved sheets of polyethylene, there being no polyethylene at the bottom or top of the Kevlar layers. If used, the film adhesive is included during this lay up to fix the Kevlar to the ceramic tile, otherwise a release film is used between the Kevlar and the ceramic tile. All edges are neat when the Kevlar/polyethylene is laid on the rear surface of the ceramic tile.

3. The ceramic tile and its backing layers are placed in a vacuum bag with breather materials to absorb excess resin and a vacuum of −50 to −100 kPa is established. The tiles and backing layers with the aforesaid vacuum conditions being maintained are placed in a vessel such as an autoclave for a controlled heat and pressure cycle for about four hours. The key sequence and requirements of this cycle being:

temperature increases from ambient;

pressure is raised and held at 100 kPa until temperature achieves 120° C.;

pressure and temperature increase until pressure reaches 700 kPa and temperature reaches 130-160° C. These minimum conditions are maintained for at least 30 minutes;

after 30 minutes, temperature is reduced to 60° C. at which point pressure is also reduced; and

the process is completed with pressure and temperature returned to ambient conditions.

4. Ceramic tiles and their semi-rigid backing panel are removed from the autoclave. They are then removed from the vacuum bags and inspected.

5. If a film adhesive is not used, a high strength adhesive (Hysol) is applied to the rear surface of the ceramic tile and the backing panel is initially fixed into position by hand.

6. If a further strength providing layer has not already been adhered to the front face of the ceramic tile, then a high strength adhesive (Hysol) may be applied to the front face of the tile and a strength providing layer such as a fibreglass spall liner is initially fixed into position by hand. The composite plate may then be covered with breather materials and sealed in a vacuum bag under low pressure for 10-25 psi.

7. The thus formed composite plate is then left for 4 hours for curing under ambient conditions.

8. The composite plates are removed from the vacuum bag, inspected and cleaned if necessary.

9. If multiple front strength providing layers are to be provided then the multiple layers may be inter-leaved with thermoplastic film layers such as polyethylene as with the backing layers and assembled as described in point 2 above with subsequent processing as defined above.

10. Finally, the back of the composite plate is sprayed with adhesive (3M) and the nylon cover is applied. Adhesive (3M) is then applied to the front of the plate and the front nylon cover sheet is applied.

1. A method of forming a hard armour panel or plate including an energy absorbing ceramic tile with a backing element providing structural strength to the energy absorbing ceramic tile adhered to a rear surface of the energy absorbing ceramic tile, said method including the steps of:
(i) forming a stack of inter-leaved layers of para-aramid fibre fabric and at least one thermoplastic film layer conforming to the peripheral shape of the energy absorbing ceramic tile;
(ii) placing said stack of inter-leaved layers onto a rear face of the energy absorbing ceramic tile and positioning the stack of inter-leaved layers and said energy absorbing ceramic tile into a vessel in which pressure and temperature is varied;
(iii) within said vessel, subjecting said stack of inter-leaved layers and the energy absorbing ceramic tile to a predetermined temperature and pressure regime for a period of time whereby said backing element is formed into a single piece having a shape conforming exactly to the contour of the rear face of said energy absorbing ceramic tile; and
(iv) utilising a high strength adhesive to adhere said backing element to the rear face of said energy absorbing ceramic tile.

2. A method according to claim 1 wherein the backing element is adhered to the rear face of said energy absorbing ceramic tile within said vessel simultaneously with conforming the shape of said backing element to the contour of the rear face of said energy absorbing ceramic tile.

3. A method according to claim 2 wherein the backing element is adhered to the rear face of the energy absorbing ceramic tile utilizing a high strength film adhesive as a final layer of said inter-leaved layers.

4. A method according to claim 1 wherein the backing element is adhered to the rear face of the energy absorbing ceramic tile externally of said vessel.

5. A method according to any one of claims 1 to 4 wherein the composite structure of said energy absorbing ceramic tile and said backing element adhered to a rear face of said energy absorbing ceramic tile is placed under vacuum conditions for a predetermined period of time.

6. A method according to any one of claims 1 to 5 wherein the composite structure includes at least one further strength providing layer adhered to a front face of the energy absorbing ceramic tile.

7. A method according to claim 6 wherein said at least one further strength providing layer is adhered to the front face of the energy absorbing tile before being placed in said vessel.

8. A method according to any one of claims 1 to 5 wherein the composite structure includes at least one further strength providing layer adhered to a front face of the energy absorbing ceramic tile, the further strength providing layer or layers being adhered to the front face of the energy absorbing tile within said vessel simultaneously with conforming of the shape of said backing element to the contour of the rear face of said energy absorbing tile.

9. A method according to claim 8 wherein at least two said further strength providing layers are provided inter-leaved with at least one thermoplastic film layer.

10. A hard armour panel or plate when made by a method according to any one of claims 1 to 9.

11. A hard armour panel or plate including an energy absorbing tile manufactred from an armour grade ceramic having a thickness between 4.0 and 12.0 mm, and a backing element providing structural strength to the energy absorbing tile, said backing element being adhered to a rear surface of said energy absorbing tile and being constructed from inter-leaved layers of para-aramid fibre fabric and thermoplastic polymer film.

12. A hard armour panel or plate according to claim 11 wherein between seven and twenty layers of the para-aramid fibre fabric are provided in said backing element with each pair being separated by at least one thermoplastic film layer.

13. A hard armour panel or plate according to claim 11 or claim 12 wherein at least one further strength providing layer is adhered to a front face of said energy absorbing tile.

14. A hard armour panel or plate according to any one of claims 11 to 13 wherein the para-aramid fibre fabric is Kevlar fibre fabric.

15. A hard armour panel or plate according to claim 13 wherein said one further strength providing layer is a fibre glass fabric layer and/or a para-aramid fibre fabric layer.
